(19) United States
(12) Patent Application Publication
(10) Pub. No.: US 2025/0165397 A1
(43) Pub. Date: May 22, 2025

(54) GROUPING OF MEMORY CELLS USING A MACHINE LEARNING MODEL RELATED APPLICATION

(71) Applicant: Microchip Technology Incorporated, Chandler, AZ (US)

(72) Inventors: Pitamber SHUKLA, San Jose, CA (US); Chris NORRIE, Castro Valley, CA (US); Igor ZIPER, Sunnyvale, CA (US); Srinivas YELISETTI, Fremont, CA (US)

(21) Appl. No.: 18/731,232

(22) Filed: May 31, 2024

Related U.S. Application Data
(60) Provisional application No. 63/601,746, filed on Nov. 21, 2023.

(51) Int. Cl. G06F 12/06

(52) U.S. Cl. CPC G06F 12/0684

(57) ABSTRACT

A controller may determine, using a machine learning model, reliability characteristic data associated with memory cells of a non-volatile memory device. The machine learning model may be trained using characterization data that identifies different reliability characteristic of one or more non-volatile memory devices. The controller may group, based on the reliability characteristic data, a first portion of the memory cells of the non-volatile memory device in a first management group, and a second portion of the memory cells of the non-volatile memory device in a second management group. The controller may manage, based on the reliability characteristic data, background scanning and logical to physical mapping of the first management group of memory cells, and the second management group of memory cells.

### RELATED APPLICATION

This application claims priority to U.S. Provisional Patent Application No. 63/601,746, for “MACHINE LEARNING BASED WORLDLINE GROUPING FOR ADAPTIVE BACKGROUND SCAN AND LOGICAL TO PHYSICAL MAPPING,” filed on Nov. 21, 2023, the content of which is incorporated by reference herein in its entirety.

### FIELD

The present disclosure generally relates to memory cells of non-volatile memory devices and, for example, grouping memory cells of non-volatile memory devices based on categorization by one or more machine learning models.

### BACKGROUND

A non-volatile memory device may include a memory device that may store data and retain the data without an external power supply. One example of a non-volatile memory device is a NAND flash memory device. In some situations, background scanning can be performed on the non-volatile memory device to promote data integrity. In some situations, if the data is from a host device, logical to physical mapping may be used to store the data on the non-volatile memory device.

### SUMMARY

In some implementations, a method comprising: determining, using a machine learning model, reliability characteristic data associated with memory cells of a non-volatile memory device, wherein the machine learning model was trained using characterization data that identifies different reliability characteristics of one or more non-volatile memory devices; grouping, based on the reliability characteristic data, a first portion of the memory cells of the non-volatile memory device in a first management group, and a second portion of the memory cells of the non-volatile memory device in a second management group; and managing, based on the reliability characteristic data, background scanning or logical to physical mapping of the first management group of memory cells, and the second management group of memory cells.

In some implementations, a solid-state drive (SSD) includes a non-volatile memory device; and a controller to: determine, using a machine learning model, reliability characteristic data associated with wordlines of the non-volatile memory device; determine, based on the reliability characteristic data, a first group of one or more first wordlines of the non-volatile memory device and a second group of one or more second wordlines of the non-volatile memory device; and perform at least one of: first background scanning of the first group of one or more first wordlines at a first frequency that is different than a second frequency of performing second background scanning of the second group of one or more second wordlines, or logical to physical mapping of data to the first group of one or more first wordlines or to the second group of one or more second wordlines based on the data being a first type of data or a second type of data.

In some implementations, a non-transitory computer-readable medium storing a set of instructions includes one or more instructions that, when executed by one or more processors of a one or more devices, cause the one or more devices to: determine, using a machine learning model, reliability characteristic data associated with wordlines of a non-volatile memory device; determine, based on the reliability characteristic data, a first group of one or more first wordlines of the non-volatile memory device and a second group of one or more second wordlines of the non-volatile memory device; and perform, based on the reliability characteristic data, at least one of: background scanning of the first group of one or more first wordlines and the second group of one or more second wordlines, or logical to physical mapping of the first group of one or more first wordlines and the second group of one or more second wordlines.

### BRIEF DESCRIPTION OF THE DRAWINGS

To easily identify the discussion of any particular element or act, the most significant digit or digits in a reference number refer to the figure number in which that element is first introduced.

FIGS. 1A-1I are diagrams of an example implementation described herein.

FIG. 2 is a diagram of example components of one or more devices of FIGS. 1A-1I.

FIGS. 3A and 3B are flowcharts of an example process associated with grouping memory cells using a machine learning model.

FIG. 4 is a flowchart of an example process associated with grouping memory cells using a machine learning model.

FIG. 5 is a flowchart of an example process associated with grouping memory cells using a machine learning model.

### DETAILED DESCRIPTION

The following detailed description of example implementations refers to the accompanying drawings. The same reference numbers in different drawings may identify the same or similar elements.

The non-volatile memory device may be included in a solid-state drive (SSD). The SSD may also include a controller. In some situations, background scanning may be performed on the non-volatile memory device to promote data integrity. Typically, the background scanning occurs on a pre-selected location that may be specified in the controller of the SSD. For example, the background scanning may be performed on a same page of a memory block (or “block”), irrespective of a type of the non-volatile memory device. In other words, a location of the background scanning does not change based on the type of the non-volatile memory device. A technical problem of performing background scanning in this manner is that the controller may be unable to determine a marginality of the block. The term “marginality” may be used herein to refer to a condition in which the block is approaching an operational limit. For example, the block may be functioning but may be approaching a condition (e.g., approaching an operational margin) that causes the block to experience data corruption or data loss. The term marginality may also apply to other components of the non-volatile memory device, such as wordlines, wires, transistors, gates, without limitation, all of which have marginal modes of operation. Additionally, a technical problem of performing background scanning in this manner is the impact on a data integrity, a quality of service (QoS), or a drive aging of the non-volatile memory device, without limitation.

Typically, the controller of the SSD causes data from a host device to be stored in a physical location of the non-volatile memory device (e.g., in one or more memory cells). The data may be stored using a logical to physical (L2P) mapping process (or simply L2P mapping). Typically, the data is stored without determining whether the data is a first type of data (e.g., “hot data”) or a second type of data (e.g., “cold data”) and without considering reliability conditions associated with the physical location. In some examples, “hot data” may refer to data from a host device while “cold data” may refer to data obtained as part of a garbage collection operation on the non-volatile memory device or as part of a wear leveling operation on the non-volatile memory device.

In some examples, “hot data” may refer to data from a host device that was recently obtained by the host device (e.g., an image captured within a couple of days of a current time) while “cold data” may refer to data that was less recently obtained by the host device (e.g., an image captured a month prior to a current time). In some examples, “hot data” may refer to data (e.g., from the host device) that is frequently accessed while “cold data” may refer to data (e.g., from the host device) that is infrequently used.

The reliability conditions may include conditions that subject the physical location to errors. The conditions may include one or more of data retention degradation, read disturb, or variations regarding cross temperature. The reliability conditions may indicate a propensity of the physical location to be subjected to errors (e.g., read errors). As used herein, “data retention degradation” may be used to refer to a degraded (or decreased) data retention of the non-volatile memory device due to loss of electrons occurring during a power-off condition of the memory device. The loss of electrons may affect threshold voltages. Accordingly, “data retention degradation” may indicate a change in threshold voltages as a result of the loss of electrons. As used herein, “read disturb” (or “read disturbance” or “read disturb event”) may be used to refer to a change in a threshold voltage of a memory cell resulting from an electrical charge applied to an adjacent (or neighboring) memory cell during one or more read operations to read data from the adjacent cell. The change in the threshold voltage (or electrical charge) may cause read errors when attempting to read data stored by the memory cell. The change in threshold voltage may occur for multiple memory cells and for multiple wordlines of a memory block. As used herein, “cross temperature” may be used to refer to performing write operations and read operations at different temperatures. In some situations, the data may be stored without considering an endurance (or write endurance) associated with the physical location. As used herein, “endurance” may refer to a number of program/erase cycles that may be sustained by the physical location without causing data corruption or data loss.

In some situations, different portions of memory cells of the non-volatile memory device (e.g., different wordlines) may have different reliability characteristics (e.g., as a result of being subjected to different data retention degradation, different read disturb, or different cross temperatures). A reliability characteristic may refer to a characteristic regarding a reliability of a portion of the non-volatile memory device with respect to storing data. The reliability characteristic may be based on (or may be affected by) different reliability conditions. For example, after a number of program/erase cycles, one or more first wordlines may be subjected to more data retention degradation and more read disturb than one or more second wordlines. As a result, the reliability characteristics of the one or more second wordlines may exceed the reliability characteristics of the one or more first wordlines. In this regard, the marginality of the one or more first wordlines may exceed the marginality of the one or more second wordlines.

In some situations, the reliability characteristics of the one or more first wordlines may be affected by physical defects associated with the one or more first wordlines. For example, variations during a manufacturing process of the non-volatile memory device may cause the physical defects of the one or more first wordlines. For instance, limitations with respect to plasma etching may cause deformation and shape variation of memory cells, such as incomplete etching, bowing, twisting, and critical dimension variation. The deformation and shape variation may cause intrinsic memory cell reliability variation within a block of the non-volatile memory device. For example, the deformation and shape variation may cause variations in reliability characteristics from one memory cell to another memory cell, thereby causing the reliability characteristics of the one or more second wordlines to exceed the reliability characteristics of the one or more first wordlines.

The first type of data (e.g., hot data) may be stored in the one or more first wordlines (instead of the one or more second wordlines) irrespective of the one or more first wordlines being subjected to more data retention degradation and more read disturb than one or more second wordlines. In other words, the controller may utilize the same L2P mapping process to store data without taking into consideration a type of data and reliability characteristics of wordlines. In this regard, the controller may use a static L2P mapping process to store data, as opposed to using a dynamic L2P mapping process that is adjusted to take into consideration the type of data and the reliability characteristics of the wordlines. The controller may not differentiate between data that is hot data or cold data while storing the data. Instead, the controller may simply store the data to a pre-determined physical location, based on the static L2P mapping, without considering the marginalities of the pre-determined location meaning. For example, the physical marginalities may be due to the predetermined location being more prone to read disturb (e.g., based on the cell geometry of the pre-determined location).

Storing data in a non-volatile memory device without taking into consideration a type of data and reliability characteristics of wordlines of the non-volatile memory devices may cause data of the first type (e.g., hot data) to be stored in wordlines with a marginality that exceeds a marginality of other wordlines. Accordingly, storing the data in this manner may increase a likelihood of the first type of data (e.g., hot data) being subjected to data corruption or data loss.

In this regard, implementations described herein are directed to addressing the technical problems regarding performing background scanning and performing an L2P mapping process described above. Implementations described herein provide a technical solution that includes grouping portions of memory cells of a non-volatile memory device based on categorizing performed by one or more machine learning models. For example, implementations described herein are directed to a technical solution that includes grouping wordlines in order to identify wordlines with marginalities and wordlines without marginalities (or in order to identify wordlines with different levels of marginalities). By identifying wordlines with marginalities, a controller (associated with the non-volatile memory device) may cause background scanning to be performed on the wordlines with marginalities to monitor the health of the wordlines. In this regard, based on the background scanning, the controller may cause a block refresh to be performed before the wordlines reach a condition that causes data corruption or data loss. Additionally, as the controller identifies additional wordlines with marginalities, the controller may cause background scanning to be performed on the additional wordlines with marginalities to monitor the health of the wordlines. For example, the controller may control the background scanning to be applied to the location of the additional wordlines with marginalities. For instance, the one or more machine learning models may be used to identify one or more wordlines with marginalities. The number and locations of one or more wordlines with marginalities may vary. Accordingly, the controller may control the background scanning to be applied to the varying number and locations of one or more wordlines. Additionally, the controller may adjust a frequency of the background scanning (e.g., increase a frequency of the background scanning at the location of the wordlines with marginalities). In some situations, the controller may cause the background scanning to be performed for a single block. Alternatively, the controller may cause the backgroup scanning to be performed on multiple blocks.

By identifying wordlines with marginalities, the controller may adjust an L2P mapping process to differentiate between the first type of data (hot data) and the second type of data (cold data). For example, in the event the controller receives a request to store a combination of hot data and cold data, the controller may prevent the hot data from being mapped to locations of the wordlines with marginalities. For example, the controller may adjust the L2P mapping (that may map cold data to the locations of the wordlines with marginalities) to map hot data to locations of the wordlines without marginalities (or with less marginalities). By adjusting the L2P mapping process as described herein, the controller may reduce read latency associated with the non-volatile memory device and may reduce a drive aging process of the non-volatile memory device. With respect to latency, when a request is provided to read data from an SSD, the data is expected to be provided rapidly and is expected to be substantially correct. Marginally operating components, such as a wordline (of the non-volatile memory device) may cause an increase in the raw bit error rate, which requires an increased amount of time to correct prior to being output. Thus, an increase in bit error rates may cause a delay in the data being read from the SSD, thereby increasing read latency. In addition, the raw bit error rate may exceed a bit error rate associated with data that can be corrected, resulting in data that may be corrupted or lost, without limitation.

The controller may use one or more machine learning models to identify wordlines with marginalities and wordlines without marginalities. Additionally, the controller may use the one or more machine learning models to group wordlines and to identify wordlines with different levels of marginalities. The one or more machine learning models may be trained using characterization data of one or more non-volatile memory devices. The characterization data may identify different reliability conditions for different program/erase (P/E) cycles. The trained one or more machine learning models may identify wordlines with marginalities and wordlines without marginalities for different types of non-volatile memory devices manufactured by different manufacturers. In some situations, the trained one or more machine learning models may identify wordlines with different levels of marginalities for different types of non-volatile memory devices manufactured by different manufacturers.

The one or more machine learning models may be trained by one or more computing devices that train machine learning models. The one or more computing devices may obtain characterization data for different portions of different types of non-volatile memory devices. For the testing of the characterization data, the non-volatile memory devices may be tested after being exposed to a variety of different operating environments (e.g., temperature), including age of device, operating intensity, distribution of frequently accessed data on the device, and other similar characteristics.

In an example, characterization data corresponding to increased marginality of a memory cell may be caused by factors including, the design of the non-volatile memory device and variations in the manufacture of the non-volatile memory device. Marginality may also increase for a memory cell of the non-volatile memory device based on the age of the memory cell, and type of usage to which the memory cell has been subject, e.g., frequency of access or modification.

In some examples, the one or more computing devices may train a single machine learning model (e.g., a single neural network) using the characterization data that identifies data retention degradation, read disturb, and cross temperature, among other examples. In some examples, the one or more computing devices may train different machine learning models using characterization data of various types of non-volatile memory devices after the non-volatile memory devices have undergone different P/E cycles. For example, the different machine leaning models may include a first machine learning model trained using characterization data of a first range of P/E cycles, a second machine learning model trained using characterization data of a second range of P/E cycles, and so on.

After training the one or more machine learning models, the one or more computing devices may provide the one or more trained machine learning models to a controller of a solid-state drive (SSD). The SSD may include a non-volatile memory device. As an example, the controller may be a firmware microcontroller (e.g., a controller that performs operations using firmware). The controller of the SSD may use the one or more trained machine learning models to categorize memory portions of the non-volatile memory device. For example, the controller of the SSD may use the one or more trained machine learning models to categorize wordlines of the non-volatile memory device into various categories for management operations (e.g., to dynamically adjust locations of background scanning and to dynamically adjust logical to physical mapping).

In some implementations, a trained machine learning model may be used to categorize wordlines (e.g., at the physical layer) of the non-volatile memory device into various categories for management operations described herein, such as background scanning and dynamically adjusting L2P mappings to differentiate between storing hot data and storing cold data. In some examples, the controller may use the trained machine learning model to identify wordlines with marginalities (or wordlines with marginalities that exceed a marginality threshold). In some situations, one wordline may be a wordline with marginalities and an adjacent wordline may be a wordline without marginalities. The adjacent wordline may be a subsequent wordline or a previous wordline. The controller may cause background scanning to be performed on the wordlines with marginalities to monitor a health of the wordlines with marginalities.

Additionally, the controller may adjust the L2P mapping process to prevent hot data from being mapped to locations of the wordlines with marginalities. For example, when wordlines are categorized based on their relative marginality, then hot data may be physically mapped to wordlines with lower relative marginality, e.g., because the wordlines with lower relative marginality may be able to handle more frequent access for a longer period of time before failure. Because the hot data may be frequently accessed, the controller may cause the hot data to be mapped to wordlines that are not susceptible (or least susceptible, or less susceptible) to read disturb. Additionally, because cold data may be infrequently accessed, the controller may cause the cold data to be mapped to wordlines that are not susceptible (or least susceptible) to data retention degradation. Adjusting the L2P mapping process as described herein may improve the read latency of memory cells of the non-volatile memory device and overall drive ageing characteristics of the non-volatile memory device. In some implementations, the controller may use data from the machine learning model to generate and maintain a data structure (e.g., a lookup table). The data structure may store information identifying one or more wordlines with marginalities in association with different program/erase cycles.

In some examples, the non-volatile memory device may be a single-level cell (SLC) NAND flash memory device, a multi-level cell (MLC) NAND flash memory device, a triple-level cell (TLC) NAND flash memory device, or a quad-level cell (QLC) flash memory device, without limitation. While some examples described herein are directed to TLC NAND flash memory devices, implementations described herein are applicable to other types of NAND flash memory devices or other non-volatile memory devices.

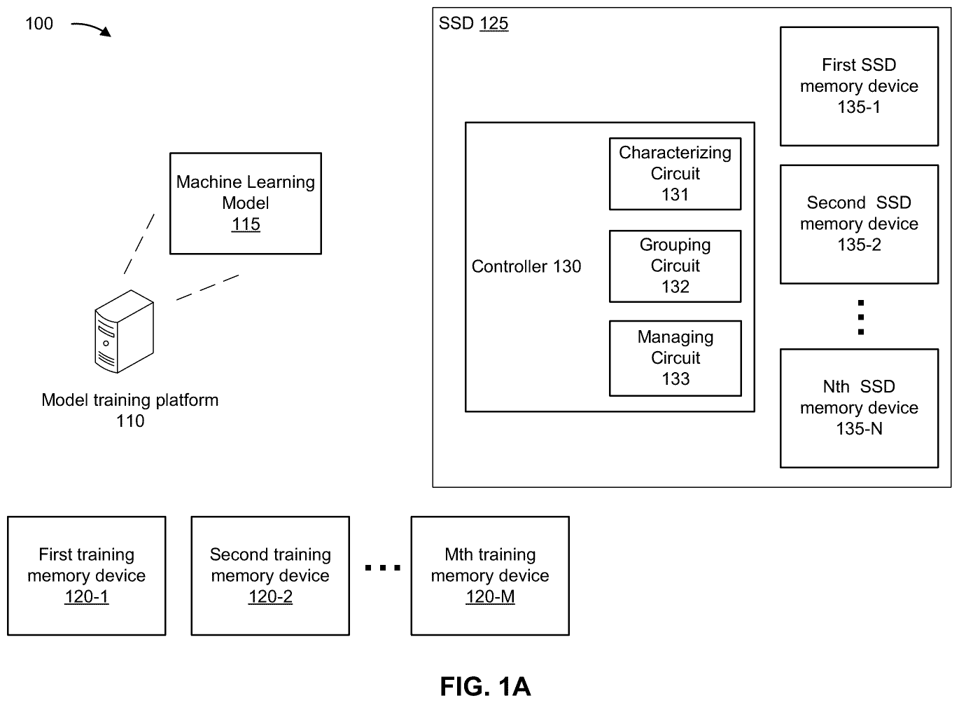

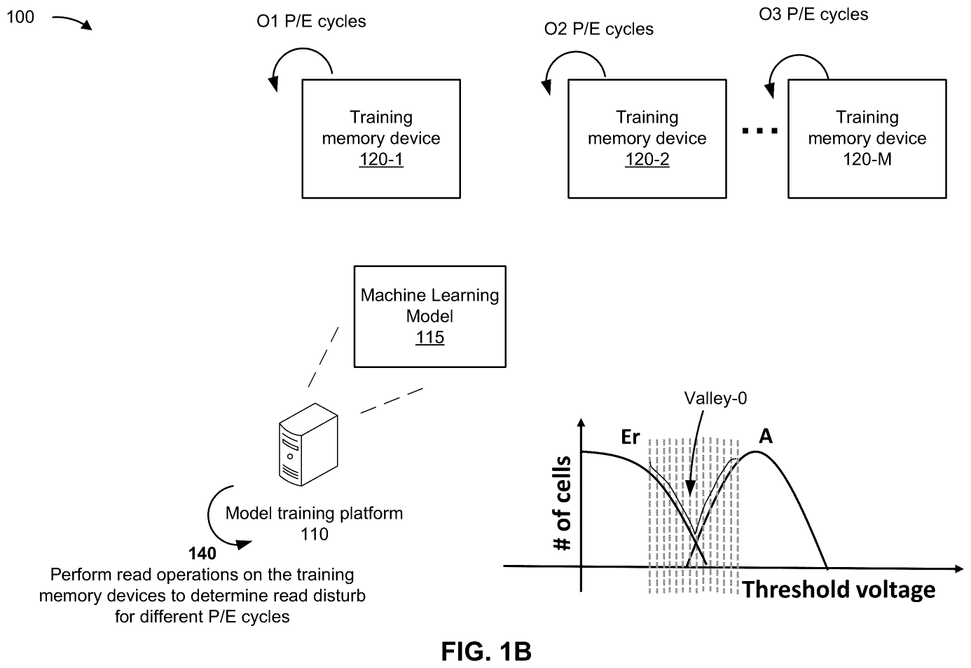

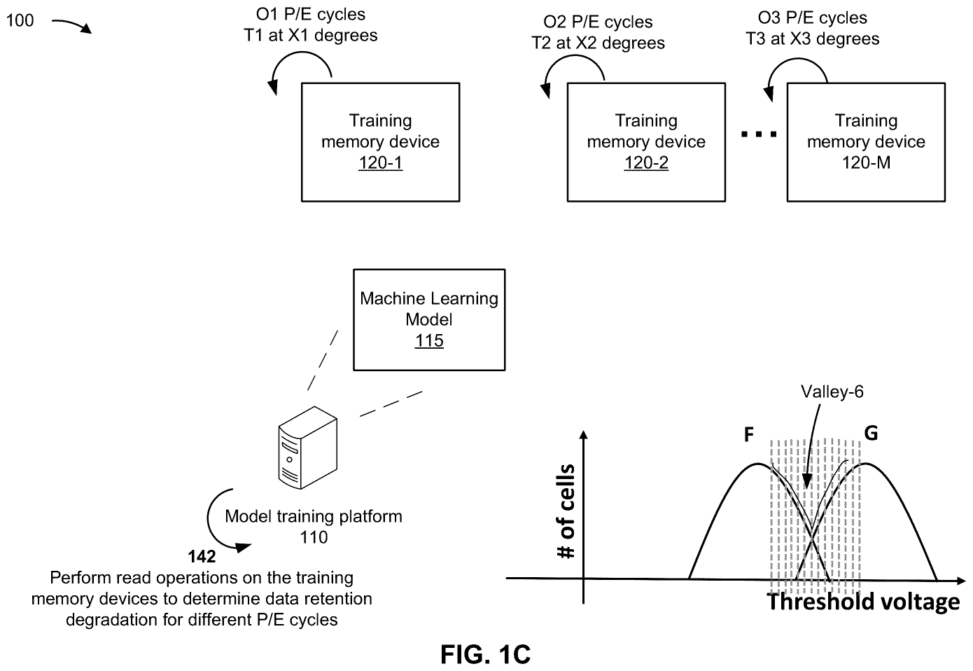

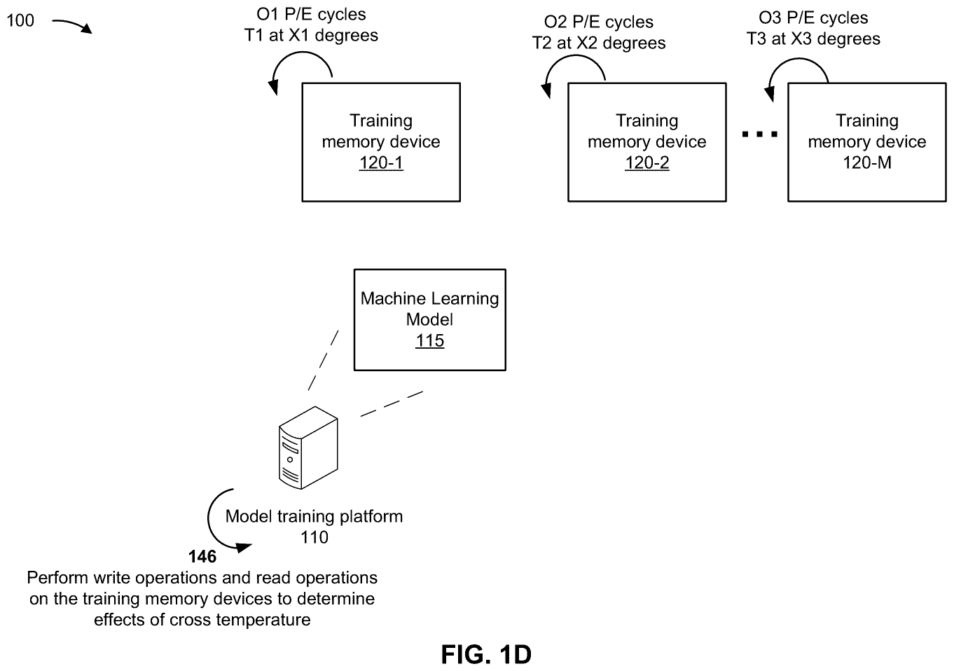

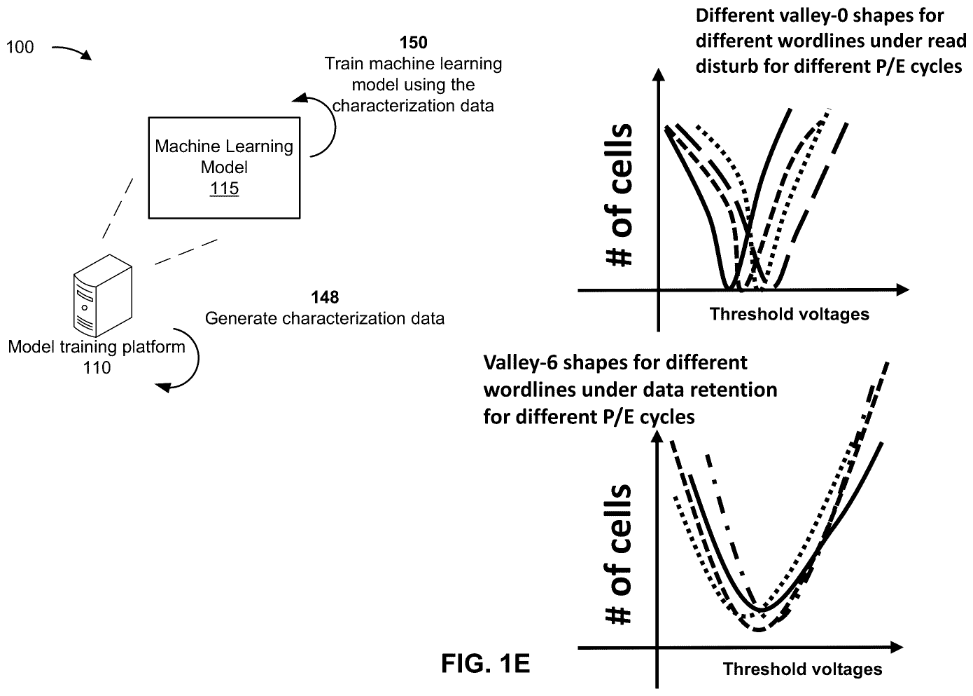

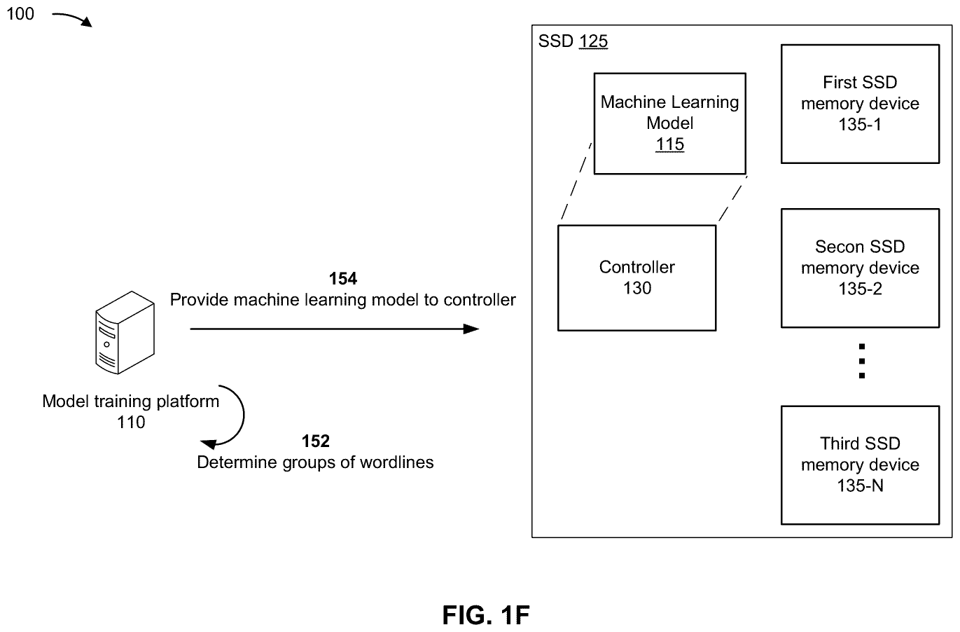

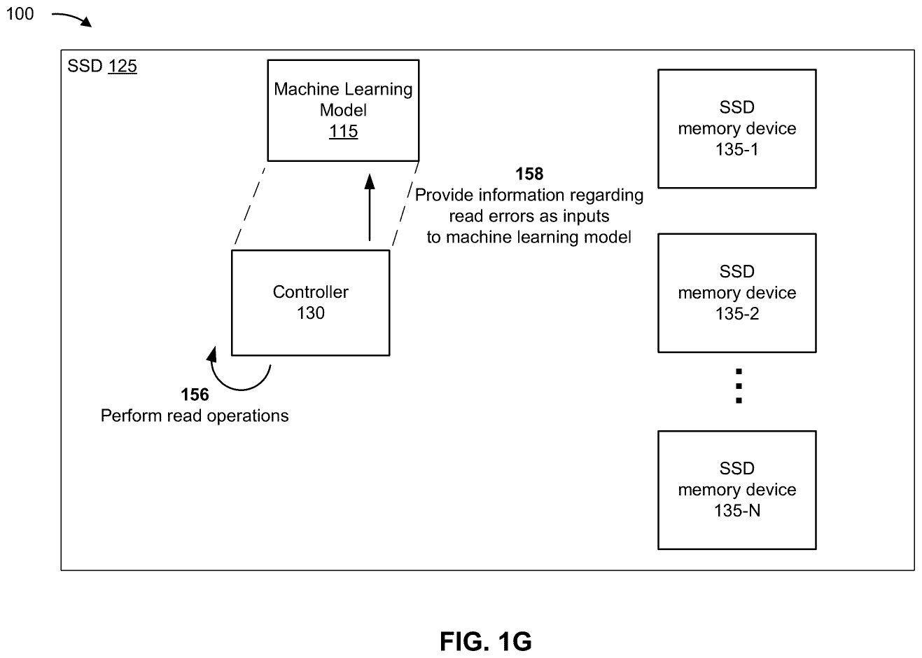

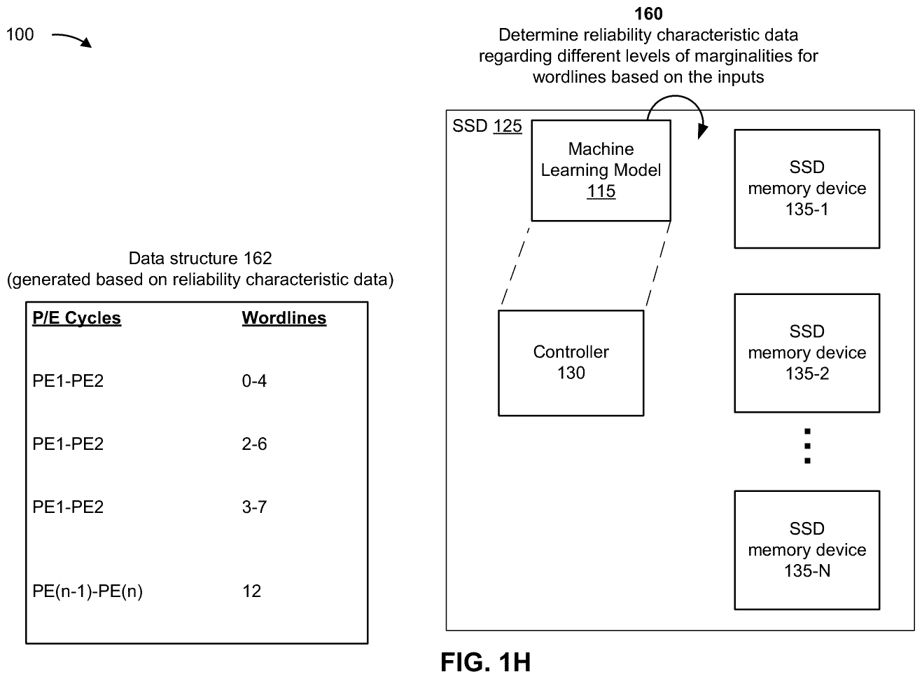

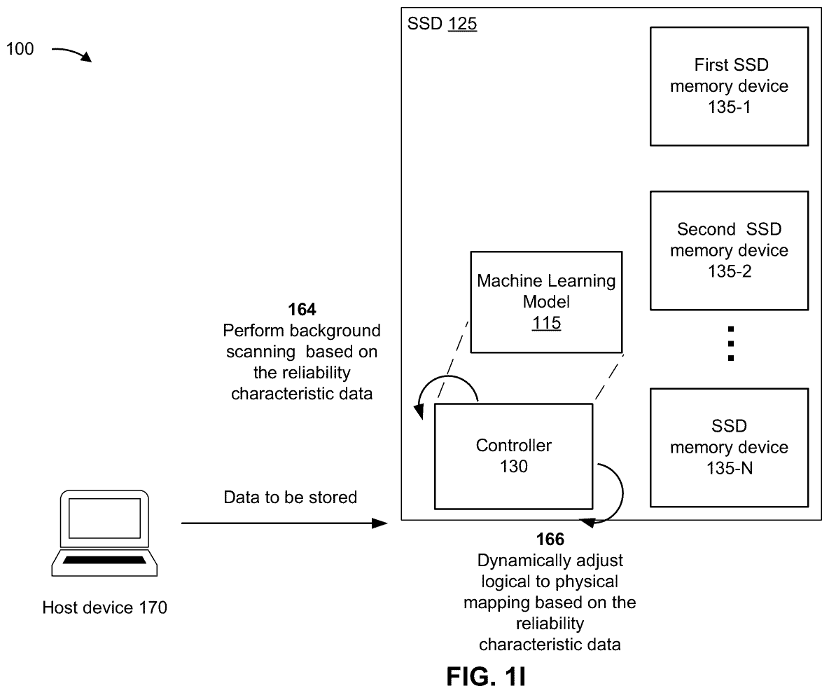

FIGS. 1A-1I are diagrams of an example implementation 100 described herein. As shown in FIG. 1A, example implementation 100 includes model training platform 110 which may include a machine learning model 115, a first training memory device 120-1, a second training memory device 120-2, up to an Mth training memory device 120-M (collectively “training memory devices 120” and individually “training memory device 120”), and an SSD 125.

Model training platform 110 may include one or more devices that train one or more machine learning models, as explained herein. Model training platform 110 may include a communication device and a computing device. For example, model training platform 110 may include a server, a laptop computer, a desktop computer, or a similar type of device. In some implementations, model training platform 110 may be a computing device that is part of a computing environment. The communication device may include an interface for communicating with other devices and the computing device may include a combination of one or more processors, controllers, firmware, software, and other logic configured to execute computing operations.

As shown in FIG. 1A, model training platform 110 may include machine learning model 115. Model training platform 110 may train machine learning model 115 and provide machine learning model 115 to a controller 130 of SSD 125. In some situations, model training platform 110 may train multiple machine learning models 115. In this regard, model training platform 110 may train and provide one or more machine learning models 115 to SSD 125.

Machine learning model 115 may include one or more neural networks trained to identify memory portions of a non-volatile memory device with marginalities. For example, machine learning model 115 may be trained to identify wordlines with different levels of marginalities. The marginalities may result from different levels of data retention degradation, different types of read disturb, and different cross temperatures. In some examples, the marginalities may indicate reliability characteristics regarding data retention degradation, reliability characteristics regarding read disturb, reliability characteristics regarding cross temperature, and reliability characteristics regarding endurance. In some situations, machine learning model 115 may group memory cells (e.g., wordlines) for dynamic (or adaptive) background scanning and L2P mapping processes. In some examples, machine learning model 115 may include a neural network model.

In some situations, machine learning model 115 may be trained, using the characterization data, to determine different groups of wordlines (e.g., different groups of wordlines). The different groups of wordlines may include different groups of memory cells. In some examples, the different groups of wordlines may be determined based on program/erase cycles of the wordlines. For example, wordlines of a first group of wordlines may be associated with a first number (or a first range) of program/erase cycles, wordlines of a second group of wordlines may be associated with a second number (or a second range) of program/erase cycles, and so on.

In some implementations, machine learning model 115 may determine the different groups of wordlines using different grouping techniques, such as hierarchical clustering, partitioning clustering, and model-based clustering. In some implementations, hierarchical clustering may be performed from the bottom-up using agglomerative hierarchical clustering, or from the top-down, using divisive hierarchical clustering. In some implementations, partition clustering may be performed by K-means clustering, dynamic clustering, or K-medoids clustering. In some implementations, model-based clustering may be based on models including polynomial models, gaussian mixed models, autoregressive integrated moving average (ARIMA) models, Markov chain models, or hidden Markov models, without limitation.

A training memory device 120 may include a non-volatile memory device, such as a flash memory device (e.g., a NAND flash memory device). The training memory device 120 may include an SLC NAND flash memory device. Alternatively, the training memory device 120 may include an MLC NAND flash memory device. Alternatively, the training memory device 120 may include a TLC NAND flash memory device. Alternatively, the training memory device 120 may include a QLC NAND flash memory device.

In some examples, training memory devices 120 may be used to generate characterization data (e.g., training data) that is used to train machine learning model 115. Training memory devices 120 may include different types of non-volatile memory devices manufactured by different manufacturers. In this regard, first characterization data may be generated for non-volatile memory devices of a first type manufactured by a first manufacturer, second characterization data may be generated for non-volatile memory devices of a second type manufactured by the first manufacturer, third characterization data may be generated for non-volatile memory devices of a third type manufactured by a third manufacturer, and so on. In some examples, the characterization data may include different bit error rates corresponding to different threshold voltages used to perform read operations on the training memory device 120.

As shown in FIG. 1A, SSD 125 may include a controller 130, a first SSD memory device 135-1, a second SSD memory device 135-2, up to an nth SSD memory device 135-N (collectively “SSD memory devices 135” and individually “SSD memory device 135”).

Controller 130 may perform operations on SSD memory devices 135. For example, controller 130 may perform read operations, write operations, erase operations, and other management operations described with embodiments, herein. In some examples, controller 130 may be implemented in an application-specific integrated circuit (ASIC). In some examples, controller 130 may perform operation using firmware stored on a memory of controller 130 (e.g., stored on a random-access memory).

As shown in FIG. 1, controller 130 may include a characterizing circuit 131, a grouping circuit 132, and a managing circuit 133. In some situation, controller 130 may maintain a lookup table for wordlines with different levels of marginalities marginal and wordlines categories per different P/E cycles. Characterizing circuit 131 may determine, using machine learning model 115, reliability characteristics of memory cells of an SSD memory device 135. For example, controller 130 may receive machine learning model 115 from model training platform 110 after machine learning model 115 has been trained, and characterizing circuit 131 may use machine learning model 115 to generate reliability characteristic data regarding the reliability characteristics of the memory cells of respective SSD memory devices 135. The reliability characteristic data may indicate marginalities resulting from various reliability conditions, such as data retention degradation, read disturb, and cross temperature. In some implementations, the reliability characteristic data used for grouping memory portions of a particular SSD memory device 135, may be based on reliability characteristic data associated with a type of training memory device 120 that corresponds to the type of the particular SSD memory device 135.

In some implementations, machine learning model 115 may be trained using characterization data that may identify intrinsic variability in the reliability over time of individual memory cells of a training memory device 120. In some implementations, characterization data may include cell deformation data associated with a manufacture process associated with the type of non-volatile memory device. For example, non-volatile memory devices may have been manufactured by different processes having different reliability characteristics. As discussed herein, certain architectures used to guide the manufacture of certain non-volatile memory devices can have different portions of memory cells subjected to certain reliability characteristics such as: incomplete etching, bowing, and other variations in the critical dimension (CD) of portions of the non-volatile memory device.

In some implementations, reliability characteristic data corresponding to the cell deformation and the manufacture process of the SSD memory device 135 may be based on existing information about one or more non-volatile memory devices. In some examples, this characterization data regarding the physical structure of the SSD memory device 135 may be accessed by controller 130 and provided to characterizing circuit 131 when assessing the marginality of the SSD memory device 135 subjected to grouping described herein.

In some examples, SSD memory devices 135 may have reliability characteristics that may change in different ways over the aging of the device, e.g., different portions of different SSD memory devices 135 may react differently to wear from various usage conditions. In some implementations, the usage of the SSD memory device 135 may include an age of the SSD memory device 134, the physical structure data associated with the type of SSD memory device 135, and other related characteristics.

In some implementations, reliability characteristic data corresponding to the SSD memory device 135 subject to wear may be based on testing of the SSD memory device 135 by controller 130, e.g., by performing testing on different portions of the SSD memory device 135. In an example, this reliability characteristic data regarding the aging of the SSD memory device 135 may be accessed by controller 130 for use by characterizing circuit 131 when assessing the marginalities of an SSD memory device 135 subject to memory grouping described herein.

Grouping circuit 132 may include one or more devices to group, based on the reliability characteristic data, a first portion of the memory cells of the SSD memory device 135 in a first management group, and a second portion of the memory cells of the SSD memory device 135 in a second management group. In some implementations, the first management group comprises first memory cells that were identified by the reliability characteristic data as having a different marginality compared to second memory cells of the second management group. Differences in the marginality of memory cells may be based on different reliability conditions, such as data retention degradation, read disturb, and cross temperature. The differences may result in different management operations performed by managing circuit 133 of controller 130, as described below. In some implementations, grouping circuit 132 may generate grouping data to identify the management groups. Managing circuit 133 may manage, based on the grouping data, background scanning of the management groups and the L2P mapping process of mapping data from a host device to physical locations of the SSD memory device 135 (e.g., the first management group of memory cells, and the second management group of memory cells). In this example, the first management group of memory cells is characterized as having a higher marginality than the second management group of memory cells. Continuing with this example, managing circuit 133 may cause the first type of data (e.g., hot data) to be mapped to and stored in the memory cells of the second management group (e.g., mapped to and stored in wordlines of the second management group). Additionally, managing circuit 133 may cause the second type of data (e.g., cold data) to be mapped to and stored in the memory cells of the first management group (e.g., mapped to and stored in wordlines of the first management group).

In this example, the second type of data is mapped to the first management group because the second type of data has a relatively lower likelihood of access, and thus the implementation selects the first management group with higher marginality. Also in this example, the first type of data is mapped to the second management group because the first type of data has a relatively higher likelihood of access, and thus the implementation selects the second management group with lower marginality.

In some examples of management performed by managing circuit 133, the first management group may be characterized as having a higher marginality than the second management group. In some implementations, because of this relatively higher marginality of the first management group, managing circuit 133 may specify the performance of background scanning on a first portion of the memory cells of the first management group more frequently than the performance of background scanning on the second portion of the memory cells of the second management group. In this example, managing circuit 133 may direct more frequent background scanning to the group with higher marginality (e.g., the first management group) because monitoring memory cells which are operating comparatively closer to their operational limits (e.g., comparatively higher marginality) than other memory cells of non-volatile memory device may provide benefits in the prevention of memory cell failure, the aging of respective memory cells, and other performance benefits described herein.

SSD memory device 135 may include a non-volatile memory device, such as a flash memory device (e.g., a NAND flash memory device). SSD memory device 135 may store data of a host computing device (not shown) connected to SSD 125. SSD memory device 135 may include an SLC NAND flash memory device, an MLC NAND flash memory device, a TLC NAND flash memory device, or a QLC NAND flash memory device. While examples herein may be described with respect to NAND flash memory device, implementations described herein may be applicable to other types of non-volatile memory devices, such as a phase change memory.

As explained herein, based on training memory devices 120, model training platform 110 may generate characterization data that is used to train machine learning model 115. The characterization data may indicate different reliability characteristics as a result of training memory devices 120 being subjected to different reliability conditions over different P/E cycles. The reliability conditions may include data retention degradation, read disturb, and cross temperatures.

As shown in FIG. 1B, and by reference number 140, model training platform 110 may perform read operations on the training memory devices to determine read disturb for different P/E cycles. In some implementations, after training memory devices 120 have been subjected to a number of program/erase cycles and to prior read operations, subsequent read operations may be performed on the training memory devices 120. In some situations, the subsequent read operations may be performed by controllers provided with training memory devices 120. Alternatively, the subsequent read operations may be performed by model training platform 110.

As an example, the subsequent read operations may be performed on a block of first training memory device 120-1 using first pre-determined threshold voltages. The first pre-determined threshold voltages may be included in in a first range of threshold voltages for a first charge state and a second range of threshold voltages for a second charge state. The first charge state and the second charge state may be overlapped charge states. As used herein, “overlapped charge states” may refer to adjacent charge states. For example, no charge states may be provided between the overlapped charge states. In some situations, overlapped charges states may refer to charge states with threshold voltage windows that may overlap.

In some situations, the prior read operations may be performed on a particular wordline of a memory block (or “block”) of first training memory device 120-1. As a result, one or more other wordlines, adjacent to the particular wordline, may be subjected to read disturb. For example, the prior read operations may alter threshold voltages of memory cells of the one or more other wordlines as a result of read operations performed on a memory cell of the particular wordline. The read disturb may be a single page read disturb, a full block read disturb, or a latent read disturb. The single page read disturb may occur as a result of multiple read operations performed on a single page. The full block read disturb may occur as a result of read operations performed on all pages of a block once, which will be counted as one block read disturb. The latent page read disturb may occur following delays between read operations.

The subsequent read operations may be performed on the one or more other wordlines using the first pre-determined threshold voltages associated with the overlapped charge states. In some examples, the subsequent read operations may include tens of read operations performed using the first pre-determined threshold voltages. Because the one or more other wordlines have been subjected to read disturb, performing the subsequent read operations using the first pre-determined threshold voltages may result in read errors.

As shown in FIG. 1B, in some examples, the two overlapped charge states may be associated with lowest threshold voltages of first training memory device 120-1 because the one or more other wordlines may be unprogrammed wordlines (e.g., a portion of cells, of the one or more other wordlines (e.g., ⅛ of the cells), may be in an erase state). Accordingly, the threshold voltages associated with the one or more other wordlines may be the lowest threshold voltages. The one or more other wordlines may be more susceptible to a migration of electrons (e.g., influx of electrons) associated with read disturb. As shown in FIG. 1B, the first pre-determined threshold voltages may form a valley (e.g., valley-0). In some examples, based on the read errors, the first pre-determined threshold voltages may be adjusted to obtain adjusted first pre-determined voltage threshold voltages. The adjusted first pre-determined threshold voltages may be used to successfully perform read operations. Subsequent to performing the additional read operations, first training memory device 120-1 may be subjected to additional program/erase cycles and additional read operations. The adjusted first pre-determined threshold voltages may form a different valley (not shown). The adjusted first pre-determined threshold voltages may be adjusted in order to successfully perform read operations. The process described herein may be repeated for different numbers of program/erase cycles. The process described herein may be performed on one or more additional training memory devices 120 in a similar manner.

As shown in FIG. 1C, and by reference number 142, model training platform 110 may perform read operations on the training memory devices to determine data retention degradation for different program/erase cycles. In some implementations, after training memory devices 120 have experienced different program/erase cycles and have been subjected to different data retention conditions (e.g., different temperatures over different periods of time), read operations may be performed on training memory devices 120. In some situations, the read operations may be performed by controllers provided with training memory devices 120. Alternatively, the read operations may be performed by model training platform 110.

In some implementations, multiple read operations may be performed on second training memory device 120-2 using second pre-determined threshold voltages. The second pre-determined threshold voltages may be included in a third range of threshold voltages for a third charge state and a fourth range of threshold voltages for a fourth charge state. The third charge state and the fourth charge state may be overlapped charge states.

Because second training memory device 120-2 has been subjected to data degradation conditions that cause loss of electrons, performing the read operations using the second pre-determined threshold voltages may result in read errors. The read operations may be performed on one or more additional training memory devices 120 in a similar manner.

As shown in FIG. 1C, in some examples, the two overlapped charge states may be associated with highest threshold voltages of second training memory device 120-2 and, accordingly, susceptible to a highest number of loss of electrons. Because the two overlapped charge states are more susceptible to the highest number of loss of electrons, knowing the data retention degradation of the two overlapped charge states may provide insight into the data retention degradation of other charge states.

As shown in FIG. 1C, the second pre-determined threshold voltages may form a valley (e.g., valley-6), as explained herein. By way of explanation, a TLC memory device may include 8 states to cover various combinations of 8 bits. The Er state covers one of the combinations and A, B, C, D, E, F, and G charge state cover remaining ones of the combination. A charge state may be represented by a distribution of increasing threshold voltages. A curve may represent the distribution of threshold voltages. Curves of overlapped charge states may overlap. An overlap region between the curves of overlapped region may form a valley. Accordingly, 7 valleys may be formed. In this regard, an overlap region between the Er state and the A charge state (associated with lowest threshold voltages) may be referred to as “valley-0.” Additionally, an overlap region between the F charge state and the G charge state (associated with highest threshold voltages) may be referred to as “valley-6.” In some examples, based on the read errors, the second pre-determined threshold voltages may be adjusted to obtain adjusted second pre-determined threshold. The adjusted second pre-determined threshold may be used to successfully perform additional read operations after the read errors. The adjusted second pre-determined threshold voltages may form a different valley (not shown). Subsequent to performing the additional read operations, second training memory device 120-2 may be subjected to additional program/erase cycles and additional data retention conditions. Accordingly, the adjusted second pre-determined threshold voltages may be further adjusted in order to successfully perform read operations following the additional program/erase cycles. The process described herein may be repeated for different numbers of program/erase cycles. The process described herein may be performed on one or more additional training memory devices 120 in a similar manner.

As shown in FIG. 1D, and by reference number 146, model training platform 110 may perform write operations and read operations on the training memory devices 120 to determine effects of cross temperature. In some implementations, after training memory devices 120 have experienced different program/erase cycles, write operations and read operations may be performed on training memory devices 120. In some situations, the write operations and read operations may be performed by controllers provided with training memory devices 120. Alternatively, the write operations and read operations may be performed by model training platform 110.

In some implementations, multiple read operations and write operations may be performed on a training memory device 120 at different temperatures. For example, a first write operation may be performed at a first temperature, a first read operation may be performed at a second temperature, a second write operation may be performed at a third temperature, a second read operation may be performed at a fourth temperature, and so on.

After the multiple read operations and write operations have been performed, read operations may be performed using third pre-determined threshold voltages. The multiple read operations may be performed at temperatures that are different than temperatures at which the write operations may be performed. Performing the multiple read operations and the write operations at the different temperatures may cause the training memory device 120 to be subjected to cross temperature. Because a portion of the training memory device 120 has been subjected to cross temperature, performing the read operations using the third pre-determined threshold voltages may result in read errors. The read operations may be performed on one or more additional training memory devices 120 in a similar manner. In some situations, model training platform 110 may determine one or more combinations of temperatures (of read and write operations) that cause more read errors.

As shown in FIG. 1E, and by reference number 148, model training platform 110 may generate characterization data. The characterization data may include training data that is used to train machine learning model 115. The characterization data may be generated based on performing the read operations to determine read disturb for the different P/E cycles, based on performing the read operations to determine the data retention degradation for the different P/E cycles, and based on performing the read operations to determine the effects of the cross temperature.

The characterization data may include information regarding the first pre-determined threshold voltages, regarding the read errors associated with using the first pre-determined threshold voltages, regarding the adjusted first pre-determined threshold voltages, regarding the read errors associated with using the adjusted first pre-determined threshold voltages, or regarding wordlines associated with the read errors, without limitation. As shown in FIG. 1E, the characterization data may include different valley shapes for different wordlines, subjected to read disturb, for different P/E cycles (or for different ranges of P/E cycles). For example, as shown in FIG. 1E, the valley-0 shape for a first range of P/E cycles is illustrated by a solid line, the valley-0 shape for a second range of P/E cycles is illustrated by a dashed line of a first pattern, the valley-0 shape for a third range of P/E cycles is illustrated by a dashed line of a second pattern, and so on. The different valley-0 shapes may illustrate shifts in threshold voltages associated with the overlapped states with lowest threshold voltages. The threshold voltages may be shifted toward higher threshold voltages as the P/E cycles increase.

The characterization data may include information regarding the second pre-determined threshold voltages, regarding the read errors associated with using the second pre-determined threshold voltages, regarding the adjusted second pre-determined threshold voltages, regarding the read errors associated with using the adjusted first pre-determined threshold voltages, or regarding wordlines associated with the read errors, without limitation. As shown in FIG. 1E, the characterization data may include different valley-6 shapes for different wordlines, subjected to data retention degradation, for different P/E cycles (or for different ranges of P/E cycles). For example, as shown in FIG. 1E, the valley-6 shape for a first range of P/E cycles is illustrated by a solid line, the valley-6 shape for a second range of P/E cycles is illustrated by a dashed line of a first pattern, the valley-6 shape for a second range of P/E cycles is illustrated by a dashed line of a second pattern, and so on. The different valley-6 shapes may illustrate shifts in threshold voltages associated with the overlapped states with highest threshold voltages. The threshold voltages may be shifted toward lower threshold voltages as the P/E cycles increase.

The characterization data may include information regarding the third pre-determined threshold voltages, regarding the read errors associated with using the third pre-determined threshold voltages, or regarding wordlines associated with the read errors, without limitation.

As shown in FIG. 1E, and by reference number 150, model training platform 110 may train machine learning model 115 using the characterization data. Machine learning model 115 may be trained to determine wordlines with marginalities and wordlines without marginalities for different types of non-volatile memory devices. In some situations, the different types of non-volatile memory devices may be manufactured by different manufacturers. In some examples, machine learning model 115 may determine wordlines with different levels of marginalities based on bit error rates corresponding to pre-determined threshold voltages (e.g., based on read errors caused by the pre-determined threshold voltages). For instance, machine learning model 115 may receive, as an input, bit error rates (corresponding to pre-determined threshold voltages that caused read errors), program erase cycles, and temperatures, among other examples. Machine learning model 115 may provide, as an output, reliability characteristic data that includes information regarding wordlines with different levels of marginalities for different program/erase cycles.

In some examples, the information identifying the wordlines, the different levels of marginalities, and the different program/erase cycles may be stored in a data structure. For example, controller 130 may store (in a memory associated with controller 130) that the data structure that includes information identifying one or more first wordlines with different levels of marginalities in association with information identifying a first range of program/erase cycles, information identifying one or more second wordlines with different levels of marginalities in association with information identifying a second range of program/erase cycles, and so on. In some examples, the memory may include a random-access memory.

As shown in FIG. 1E, the characterization data may be used to determine different valley shapes (e.g., valley-0 shapes) for wordlines under read disturb for different program/erase cycles. Typically, memory cells associated with lowest threshold voltages are most impacted by read disturb. Accordingly, the valley of the overlapped charges states with lowest threshold voltages (e.g., valley-0) may be a good proxy for read disturb. In some examples, a shift of the shapes toward the lowest threshold voltages may indicate changes in threshold voltages due to migration of electrons caused by read disturb. In this regard, the shift of the shapes toward the lowest threshold voltages may indicate increased read disturb. As shown in FIG. 1E, the characterization data may be used to determine different valley shapes (e.g., valley-6 shapes) for wordlines under data retention degradation for different program/erase cycles. Typically, memory cells associated with highest threshold voltages are most impacted by electron migration, and hence most impacted by data retention degradation. Accordingly, the valley of the overlapped charges states with highest threshold voltages (e.g., valley-6) may be a good proxy for data retention degradation. In some examples, a shift of the shapes toward the highest threshold voltages may indicate changes in threshold voltages due to migration of electrons caused by data retention degradation. In this regard, the shift of the shapes toward the highest threshold voltages may indicate increased data retention degradation.

As shown in FIG. 1F, and by reference number 152, model training platform 110 may determine groups of wordlines. In some situations, the characterization data may be used to determine groups of wordlines from the wordlines identified by the characterization data. In some examples, the groups of wordlines may be determined based on program/erase cycles, as explained herein. In some examples, the groups of wordlines may be determined based on signature of threshold voltages. For example, wordlines of a first of groups of wordlines may be associated with a first signature of threshold voltages, wordlines of a second of groups of wordlines may be associated with a second signature of threshold voltages, and so on. Similarly, the groups of wordlines may be determined based on error rates (e.g., bit error rates) associated with the wordlines, based on a frequency of access or pattern of access of the wordlines, among other examples.

The groups of wordlines may be determined using clustering techniques that include, but are not limited to, hierarchical clustering, partitioning clustering, or model-based clustering as explained herein. In some implementations, the groups of wordlines may be determined by machine learning model 115. Alternatively, the groups of wordlines may be determined by model training platform 110.

As shown in FIG. 1F, and by reference number 154, model training platform 110 may provide a machine learning model (e.g., machine learning model 115) to controller 130. After training machine learning model 115, model training platform 110 may provide machine learning model 115 to controller 130 of SSD 125.

In some implementations, controller 130 may utilize offline training of machine learning models. For example, in preparation for management of SSD memory devices 135, a combination of machine learning models 115 may be trained based on different reliability characteristics, then provided to controller 130, as shown by reference number 154, for use in grouping memory cells of SSD memory devices 135 of SSD 125.

As shown in FIG. 1G, and by reference number 156, controller 130 may perform read operations. For example, model training platform 110 may perform read operations on a page of a block of first SSD memory device 135-1. In some situations, the block may be pre-identified (e.g., based on a frequency of program/erase cycles for the block). In some situations, the block may be randomly selected. Controller 130 may perform the read operations using default threshold voltages (e.g., default read levels that may be used as a first guess which was provided by first SSD memory device 135-1). In some situations, because of read disturb and data retention degradation, first SSD memory devices 135-1 may have experienced loss of electrons (e.g., loss of electrons may have occurred on the block). Accordingly, performing the read operations using the default threshold voltages may result in read errors. In some situations, the default threshold voltages may include the pre-determined threshold voltages discussed herein.

As shown in FIG. 1G, and by reference number 158, controller 130 may provide information regarding the read errors as inputs to machine learning model 115. For example, model training platform 110 may provide (to machine learning model 115) information identifying bit error rates corresponding to the pre-determined threshold voltages as inputs to machine learning model 115. In some examples, controller 130 may provide, as part of the inputs, information regarding a number of program/erase cycles regarding the block and information regarding wordlines of the block. In some examples, the information regarding the wordlines may include threshold voltages associated with the wordlines, information regarding error rates (e.g., bit error rates after correction) associated with the wordlines, information regarding a frequency of access and pattern of access of the wordlines, among other examples. In some examples, the information regarding the wordlines may be used by machine learning model 115 to determine different groups of wordlines.

As shown in FIG. 1H, and by reference number 160, controller 130 may determine different levels of marginalities for wordlines based on the inputs. For example, machine learning model 115 may provide, as an output, reliability characteristic data that includes information regarding different levels of marginalities for wordlines based on the inputs. In some implementations, the output may include information regarding different groups of wordlines and information regarding different levels of marginalities for the different groups of wordlines.

As an example, controller 130 may use machine learning model 115 to determine different levels of marginalities for the different groups of wordlines based on the inputs. In some implementations, the different levels of marginalities may indicate reliability characteristics regarding different levels of read disturb for different program/erase cycles, reliability characteristics regarding different levels of data retention degradation for different program/erase cycles, reliability characteristics regarding different levels of read disturb (e.g., different levels of different types of read disturb) for different program/erase cycles, or reliability characteristics regarding endurance, among other examples of reliability characteristics.

In some implementations, machine learning model 115 may use bit error rates corresponding to the pre-determined threshold voltages (provided as inputs) to determine a valley of overlapped charge states. For example, machine learning model 115 may determine different shapes of the valley of overlapped charge states. In some situations, in order to determine the reliability characteristics regarding read disturb, machine learning model 115 may determine shapes of the valley of overlapped charge states associated with the lowest threshold voltages. In some situations, based on the number of program/erase cycles identified in the inputs, machine learning model 115 may determine shapes of the valley corresponding to different numbers (or different ranges of numbers) of program/erase cycles. Machine learning model 115 may determine a shift of the shapes toward the lowest threshold voltages. The shift may indicate changes in threshold voltages due to migration of electrons caused by read disturb. In this regard, the shift of the shapes toward the lowest threshold voltages may indicate increased read disturb.

In some situations, in order to determine the reliability characteristics regarding data retention degradation, machine learning model 115 may determine the shape of the valley of overlapped charge states associated with the highest threshold voltages. In some situations, based on different numbers (or different ranges of numbers) of program/erase cycles identified in the inputs, machine learning model 115 may determine different shapes of the valley. Machine learning model 115 may determine a shift of the shapes toward the highest threshold voltages. The shift may indicate changes in threshold voltages due to migration of electrons caused by data retention degradation. In this regard, the shift of the shapes toward the highest threshold voltages may indicate increased data retention degradation. Machine learning model 115 may perform similar operations to determine the reliability characteristics regarding cross temperature, regarding endurance, among other examples.

In some implementations, a shift of threshold voltages may correspond to a level of marginality. In this regard, as the shift of threshold voltages increases, the level of marginality increases. For example, if a shift of threshold voltages for a first group of wordlines exceeds a shift of threshold voltages for a second group wordlines, then a marginality of the first group of wordlines exceeds a marginality of the second group of wordlines. In some examples, a shift of threshold voltages for a group of wordlines (or a group of memory cells) may be determined as an average of shifts for all wordlines of the group.

In some implementations, based on the output from machine learning model 115, controller 130 may store information identifying the wordlines, the different levels of marginalities, and the different program/erase cycles. For example, the information included in the reliability characteristic data may be stored in a data structure 162, as described herein.

As shown in FIG. 1I, and by reference number 164, controller 130 may perform background scanning based on the reliability characteristic data. For example, instead of repeatedly performing background scanning on a static portion of first SSD memory device 135-1, controller 130 may utilize the reliability characteristic data of machine learning model 115 to identify portions of first SSD memory device 135-1 with a higher level of marginality relative to other portions of first SSD memory device 135-1, and perform background scanning on the identified portions of first SSD memory device 135-1 with higher level of marginality. In some implementations, a portion of first SSD memory device 135-1 may correspond to a group of wordlines (or a group of memory cells).

In an example, a first management group identified by grouping circuit 132 may include first memory cells that were identified by the data retention degradation data as having a higher marginality compared to second memory cells of the second management group. Based on this higher marginality compared to the second memory cells, an implementation may perform a first background scan of the first portion of the first memory cells more frequently than performance of a second background scan of the second portion of the second management group.

In some examples, the first memory cells may be part of one or more wordlines. Accordingly, controller 130 may perform the background scanning more frequently on the one or more wordlines. In some implementations, based on a capability of controller 130 or of SSD 125, controller 130 may perform the background scanning more frequently on a single wordline. The single wordline may have a marginality that exceeds marginalities of other wordlines of the one or more wordlines. In some implementations, based on the capability of controller 130 or of SSD 125, controller 130 may perform the background scanning more frequently on multiple wordlines. The multiple wordlines may have marginalities that exceed marginalities of other wordlines of the one or more wordlines. In other words, the background scanning may be prioritized based on levels of marginalities.

As further shown in FIG. 1I and by reference number 166, controller 130 may dynamically adjust logical to physical mapping based on the reliability characteristic data. For example, logical to physical mapping of data stored on first SSD memory device 135-1 may be altered based on the reliability characteristic data. In some implementations, logical to physical mapping may be managed by controller 130 based on a logical to physical table (L2P table). In some implementations, an L2P table may be a mapping data structure used by the firmware to translate logical addresses (e.g., addresses a host device 170 uses to access data) to physical addresses (e.g., the actual memory cell locations on SSD memory device 135 where data is stored). Host device 170 may include a server, a laptop computer, a desktop computer, a mobile device, a tablet computer, a smart phone, a camera device, a mainframe computer, a quantum computer, among other examples of computers or mobile devices.

In some implementations, controller 130 may determine whether data (to be stored) is the first type of data (e.g., hot data) or the second type of data (e.g., cold data). In some situations, the data to be stored may be provided with metadata that may be used to determine whether the data is the first type of data or the second type of data. For example, the metadata may indicate that the data was obtained as part of a garbage collection operation on first SSD memory device 135-1 or as part of a wear leveling operation on first SSD memory device 135-1. Accordingly, controller 130 may determine that the data is the second type of data. Alternatively, the metadata may indicate that the data was obtained from host device 170. Accordingly, controller 130 may determine that the data is the first type of data. In some situations, controller 130 may determine that the data from host device 170 is the first type of data if the data is frequently accessed or is the second type of data if the data is infrequently accessed.

In an example where controller 130 receives first data from host device 1170 with second type of data (e.g., obtained from a garbage collection operation or a wear leveling operation), an adaptive adjustment of logical to physical mapping may improve the intrinsic memory cell reliability, data integrity, QoS, or the life of first SSD memory device 135-1, without limitation. For example, if a marginality of a first group of wordlines exceeds a marginality of a second group of wordlines, controller 130 may map the first data to the second group of wordlines and map the second data to the first group of wordlines. The first data may be mapped to the second group of wordlines (instead of the first group of wordlines) because the first data is the first type of data and because the second group of wordlines is subject to less marginalities than the first group of wordlines.

Conversely, the second data may be mapped to the first group of wordlines (instead of the second group of wordlines) because the second data is the second type of data and because the first group of wordlines is subject to more marginalities than the second group of wordlines. In other words, controller 130 may dynamically adjust the logical to physical mapping for the first type of data to ensure that the first type of data is mapped to wordlines (or memory cells) that are subject to a least amount of read disturb, data retention degradation, or cross temperature, without limitation. In some situations, when performing logical to physical mapping of data (from host device 170) that is infrequently accessed, controller 130 may use the reliability characteristic data to identify a group of wordlines least subject to data retention degration and may map the data to the group of wordlines.

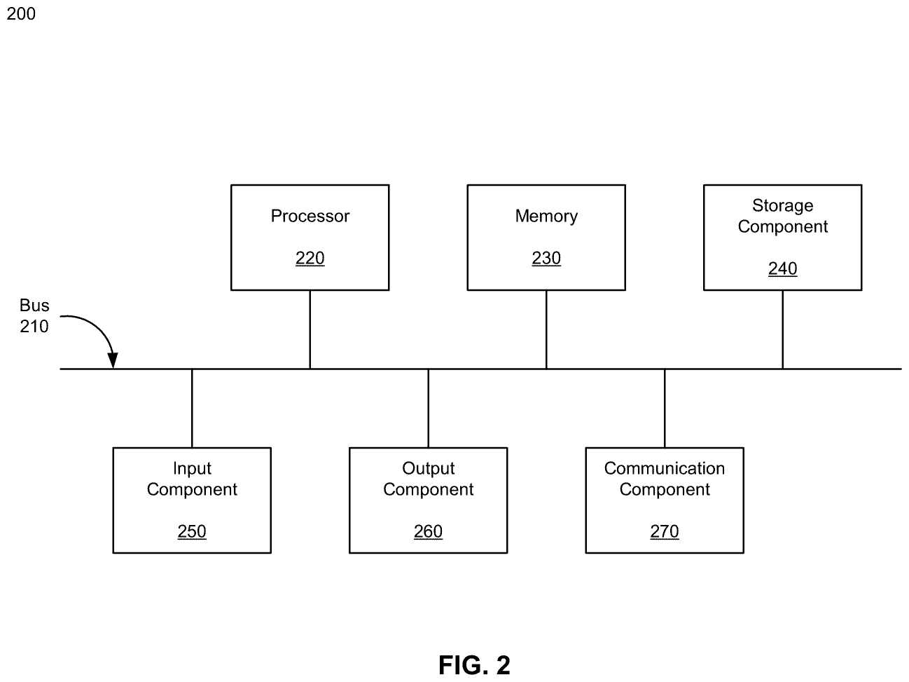

FIG. 2 is a diagram of example components of a device 200, which may correspond to one or more devices of FIG. 1, such as model training platform 110. In some implementations, model training platform 110 may include one or more devices 200 and one or more components of device 200. As shown in FIG. 2, device 200 may include a bus 210, a processor 220, a memory 230, a storage component 240, an input component 250, an output component 260, and a communication component 270.

Bus 210 includes a component that enables wired or wireless communication among the components of device 200. Processor 220 includes a central processing unit, a graphics processing unit, a microprocessor, a controller, a microcontroller, a digital signal processor, a field-programmable gate array, an application-specific integrated circuit, or another type of processing component. Processor 220 is implemented in hardware, firmware, or a combination of hardware and software. In some implementations, processor 220 includes one or more processors capable of being programmed to perform a function. Memory 230 includes a random-access memory, a read only memory, or another type of memory (e.g., a flash memory, a magnetic memory, or an optical memory).

Storage component 240 stores information or software related to the operation of device 200. For example, storage component 240 may include a hard disk drive, a magnetic disk drive, an optical disk drive, a solid-state disk drive, a compact disc, a digital versatile disc, or another type of non-transitory computer-readable medium. Input component 250 enables device 200 to receive input, such as user input or sensed inputs. For example, input component 250 may include a touch screen, a keyboard, a keypad, a mouse, a button, a microphone, a switch, a sensor, a global positioning system component, an accelerometer, a gyroscope, or an actuator. Output component 260 enables device 200 to provide output, such as via a display, a speaker, or one or more light-emitting diodes. Communication component 270 enables device 200 to communicate with other devices, such as via a wired connection or a wireless connection. For example, communication component 270 may include a receiver, a transmitter, a transceiver, a modem, a network interface card, or an antenna.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

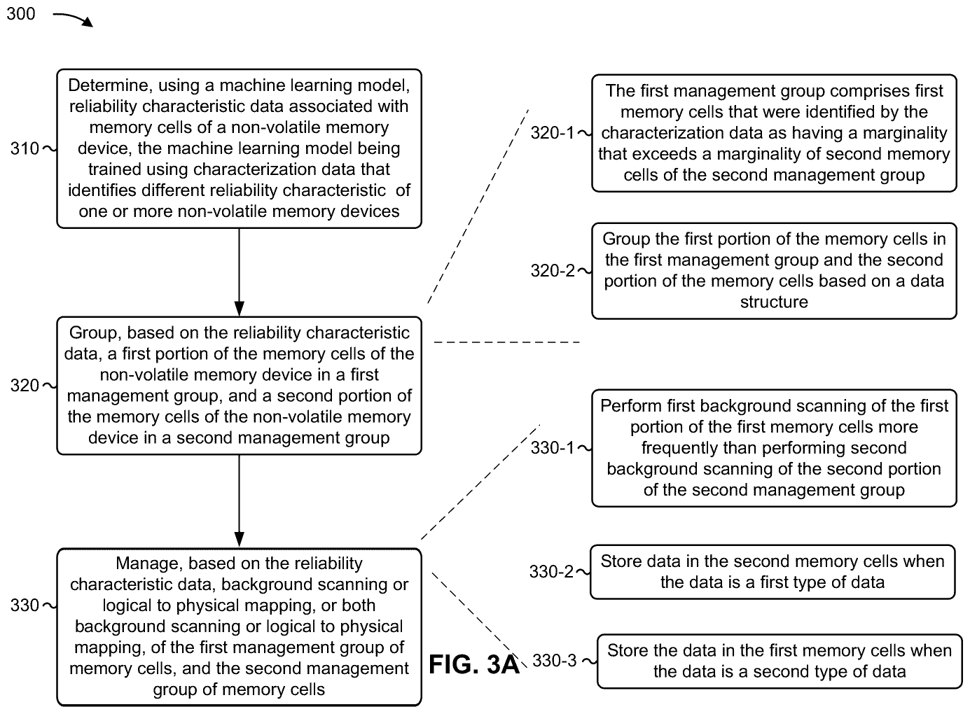

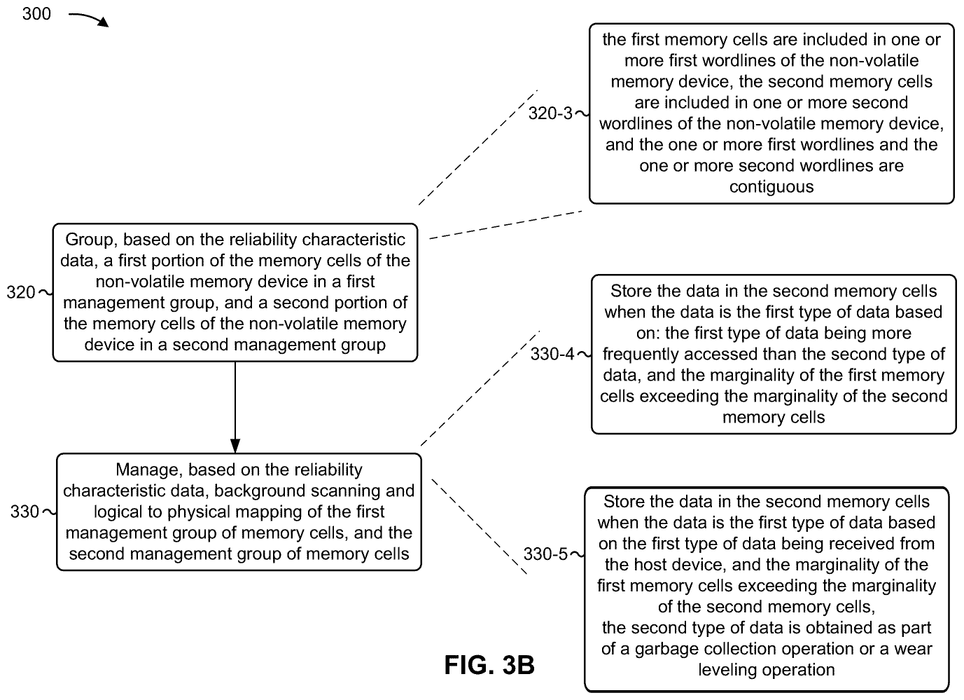

FIGS. 3A and 3B are flowcharts of an example process 300 associated with grouping memory cells using a machine learning model. In some implementations, one or more process blocks of FIG. 1 may be performed by a controller (e.g., controller 130). In some implementations, one or more process blocks of FIG. 1 may be performed by another device or a group of devices separate from, or including, the device, such as a model training platform (e.g., model training platform 110). Additionally, or alternatively, one or more process blocks may be performed by one or more components of device 200, such as processor 220, memory 230, storage component 240, input component 250, output component 260, and/or communication component 270.

As shown in FIG. 3A, process 300 may include determining, using a machine learning model, reliability characteristic data associated with memory cells of a non-volatile memory device, wherein the machine learning model was trained characterization data that identifies different reliability characteristic of one or more non-volatile memory devices (block 310). For example, the controller may determine, using a machine learning model, reliability characteristic data associated with memory cells of a non-volatile memory device, wherein the machine learning model was trained with characterization data that identifies different reliability characteristic of one or more non-volatile memory devices, as described above. In some implementations, the machine learning model was trained with characterization data that identifies different reliability characteristic of one or more non-volatile memory devices.

As further shown in FIGS. 3A and 3B, process 300 may include grouping, based on the reliability characteristic data, a first portion of the memory cells of the non-volatile memory device in a first management group, and a second portion of the memory cells of the non-volatile memory device in a second management group (block 320). For example, the controller may group, based on the reliability characteristic data, a first portion of the memory cells of the non-volatile memory device in a first management group, and a second portion of the memory cells of the non-volatile memory device in a second management group, as described above.

In some implementations, the first management group comprises first memory cells that were identified by the characterization data as having a marginality that exceeds a marginality of second memory cells of the second management group (block 320-1). In some implementations, grouping the first portion of the memory cells in the first management group and the second portion of the memory cells comprises grouping the first portion of the memory cells in the first management group and the second portion of the memory cells based on a data structure, wherein the data structure is generated based on reliability characteristic data related to the data structure (block 320-2).

As further shown in FIGS. 3A and 3B, process 300 may include managing, based on the reliability characteristic data, background scanning or logical to physical mapping, or both background scanning and logical to physical mapping, of the first management group of memory cells, and the second management group of memory cells (block 330). For example, the controller may manage, based on the reliability characteristic data, background scanning or logical to physical mapping, or both background scanning and logical to physical mapping, of the first management group of memory cells, and the second management group of memory cells, as described above.

In some implementations, managing the background scanning or logical to physical mapping, or both background scanning and logical to physical mapping, comprises performing first background scanning of the first portion of the first memory cells more frequently than performing second background scanning of the second portion of the second management group (block 330-1).

In some implementations, managing the background scanning or the logical to physical mapping, or both background scanning and logical to physical mapping, comprises storing data in the second memory cells when the data is a first type of data (block 330-2), and storing the data in the first memory cells when the data is a second type of data (block 330-3).

In some implementations, as shown in FIG. 3B, the first type of data is more frequently accessed than the second type of data, and wherein storing the data in the second memory cells comprises storing the data in the second memory cells when the data is the first type of data based on the first type of data being more frequently accessed than the second type of data, and the marginality of the first memory cells exceeding the marginality of the second memory cells (block 330-4).

In some implementations, as shown in FIG. 3B, the first type of data is received from a host device, wherein the second type of data is obtained as part of a garbage collection operation or a wear leveling operation, and wherein storing the data in the second memory cells comprises storing the data in the second memory cells when the data is the first type of data based on the first type of data being received from the host device, and the marginality of the first memory cells exceeding the marginality of the second memory cells (block 330-5).

In some implementations, the first memory cells comprise a first group of one or more first wordlines of the non-volatile memory device, wherein the second memory cells comprise a second group of one or more second wordlines of the non-volatile memory device, and wherein the one or more first wordlines and the one or more second wordlines are contiguous (block 320-3).

Although FIGS. 3A and 3B show example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

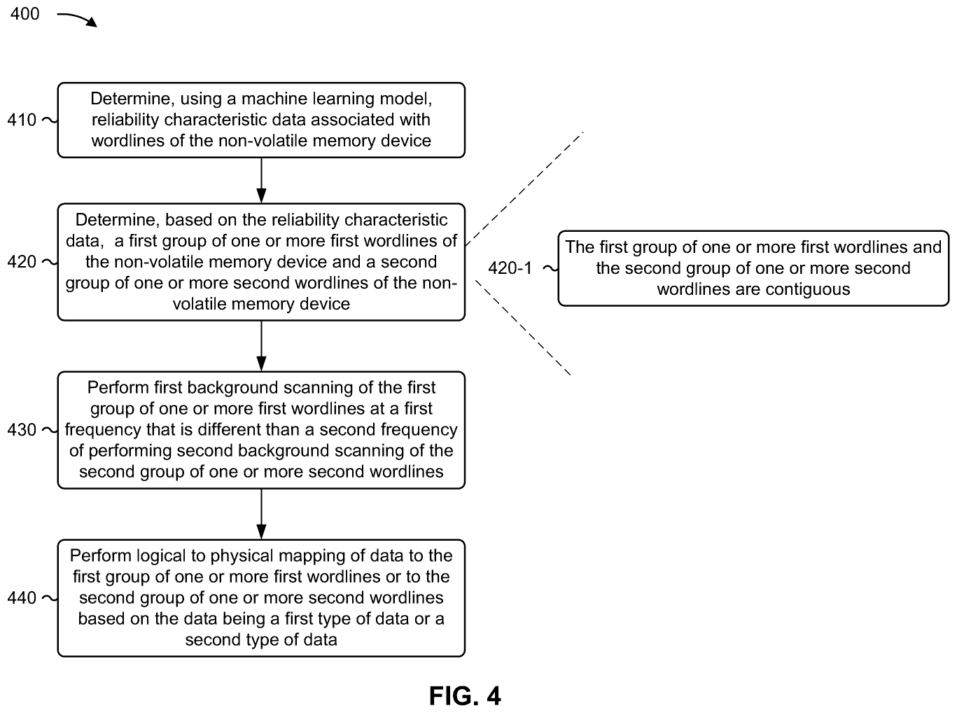

FIG. 4 is a flowchart of an example process 400 associated with grouping memory cells using a machine learning model. In some implementations, one or more process blocks of FIG. 1 may be performed by a controller (e.g., controller 130). In some implementations, one or more process blocks may be performed by another device or a group of devices separate from or including the device, such as a model training platform (e.g., model training platform 110). Additionally, or alternatively, one or more process blocks may be performed by one or more components of device 200, such as processor 220, memory 230, storage component 240, input component 250, output component 260, and/or communication component 270.

As shown in FIG. 4, process 400 may include determining, using a machine learning model, reliability characteristic data associated with wordlines of the non-volatile memory device (block 410). For example, the device may determine, using a machine learning model, reliability characteristic data associated with wordlines of the non-volatile memory device, as described above.

As further shown in FIG. 4, process 400 may include determining, based on the reliability characteristic data, a first group of one or more first wordlines of the non-volatile memory device and a second group of one or more second wordlines of the non-volatile memory device (block 420). For example, the device may determine, based on the reliability characteristic data, a first group of one or more first wordlines of the non-volatile memory device and a second group of one or more second wordlines of the non-volatile memory device, as described above. In some implementations, the first group of one or more first wordlines and the second group of one or more second wordlines are contiguous (block 420-1).

As further shown in FIG. 4, process 400 may include performing first background scanning of the first group of one or more first wordlines at a first frequency that is different than a second frequency of performing second background scanning of the second group of one or more second wordlines (block 430). For example, the device may perform first background scanning of the first group of one or more first wordlines at a first frequency that is different than a second frequency of performing second background scanning of the second group of one or more second wordlines, as described above.

As further shown in FIG. 4, process 400 may include performing logical to physical mapping of data to the first group of one or more first wordlines or to the second group of one or more second wordlines based on the data being a first type of data or a second type of data (block 440). For example, the device may perform logical to physical mapping of data to the first group of one or more first wordlines or to the second group of one or more second wordlines based on the data being a first type of data or a second type of data, as described above.

Process 400 may include additional implementations, such as any single implementation or any combination of implementations described below and/or in connection with one or more other processes described elsewhere herein.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

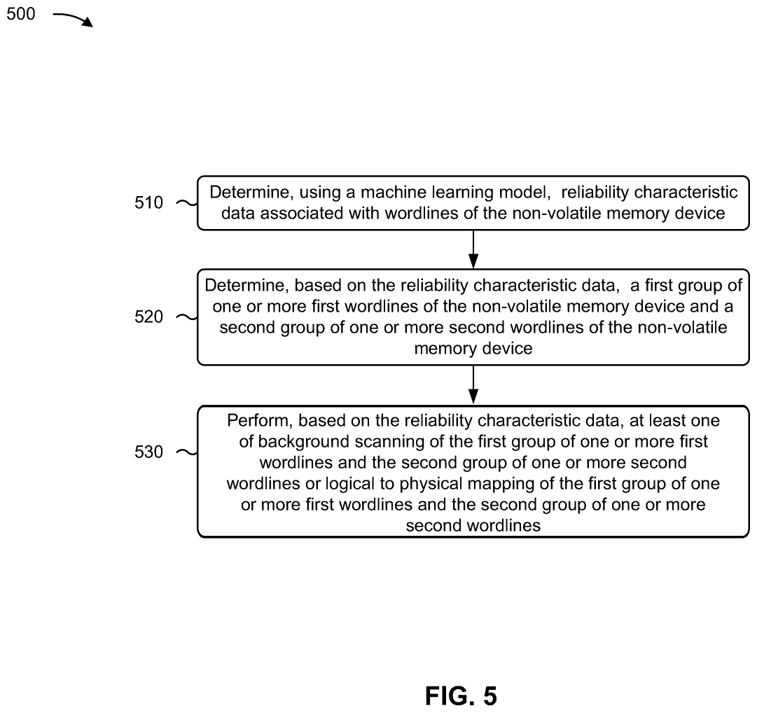

FIG. 5 is a flowchart of an example process 500 associated with grouping memory cells using a machine learning model. In some implementations, one or more process blocks of FIG. 5 may be performed by a controller (e.g., controller 130). In some implementations, one or more process blocks of FIG. 5 may be performed by another device or a group of devices separate from or including the device, such as a model training platform (e.g., model training platform 110). Additionally, or alternatively, one or more process blocks of FIG. 5 may be performed by one or more components of device 200, such as processor 220, memory 230, storage component 240, input component 250, output component 260, and/or communication component 270.

As shown in FIG. 5, process 500 may include determining, using a machine learning model, reliability characteristic data associated with wordlines of the non-volatile memory device (block 510). For example, the device may determine, using a machine learning model, reliability characteristic data associated with wordlines of the non-volatile memory device, as described above.

As further shown in FIG. 5, process 500 may include determining, based on the reliability characteristic data, a first group of one or more first wordlines of the non-volatile memory device and a second group of one or more second wordlines of the non-volatile memory device (block 520). For example, the device may determine, based on the reliability characteristic data, a first group of one or more first wordlines of the non-volatile memory device and a second group of one or more second wordlines of the non-volatile memory device, as described above.

As further shown in FIG. 5, process 500 may include performing, based on the reliability characteristic data, one, or both, of background scanning and logical to physical mapping of the first group of one or more first wordlines and the second group of one or more second wordlines (block 530). For example, the device may perform, based on the reliability characteristic data, one, or both, of background scanning and logical to physical mapping of the first group of one or more first wordlines and the second group of one or more second wordlines, as described above.

Process 500 may include additional implementations, such as any single implementation or any combination of implementations described below and/or in connection with one or more other processes described elsewhere herein.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems or methods described herein may be implemented in different forms of hardware, firmware, or a combination of hardware and software. The actual specialized control hardware or software code used to implement these systems or methods is not limiting of the implementations. Thus, the operation and behavior of the systems or methods are described herein without reference to specific software code—it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed:

1. A method comprising:
determining, using a machine learning model, reliability characteristic data associated with memory cells of a non-volatile memory device;
grouping, based on the reliability characteristic data, a first portion of the memory cells of the non-volatile memory device in a first management group, and a second portion of the memory cells of the non-volatile memory device in a second management group; and
managing, based on the reliability characteristic data, background scanning or logical to physical mapping of the first management group of memory cells, and the second management group of memory cells.

2. The method of claim 1, wherein the first management group comprises first memory cells of the non-volatile memory device that were identified by the reliability characteristic data as having a marginality that exceeds a marginality of second memory cells of the non-volatile memory device of the second management group.

3. The method of claim 2, wherein managing the background scanning and logical to physical mapping comprises:
performing first background scanning of the first portion of the first memory cells of the non-volatile memory device more frequently than performing second background scanning of the second portion of the second management group of the non-volatile memory device.

4. The method of claim 2, wherein managing the background scanning and the logical to physical mapping comprises:
storing data in the second memory cells of the non-volatile memory device when the data is a first type of data; and
storing the data in the first memory cells of the non-volatile memory device when the data is a second type of data.

5. The method of claim 4, wherein the first type of data is more frequently accessed than the second type of data, and
wherein storing the data in the second memory cells of the non-volatile memory device comprises storing the data in the second memory cells when the data is the first type of data based on:
the first type of data being more frequently accessed than the second type of data, and
the marginality of the first memory cells of the non-volatile memory device exceeding the marginality of the second memory cells.

6. The method of claim 4, wherein the first type of data is received from a host device,
wherein the second type of data is obtained as part of a garbage collection operation or a wear leveling operation, and
wherein storing the data in the second memory cells of the non-volatile memory device comprises storing the data in the second memory cells of the non-volatile memory device when the data is the first type of data based on:
the first type of data being received from of the non-volatile memory device the host device, and
the marginality of the first memory cells exceeding the marginality of the second memory cells of the non-volatile memory device.

7. The method of claim 2, wherein grouping the first portion of the memory cells in the first management group and the second portion of the memory cells in the second management group comprises:
grouping the first portion of the memory cells in the first management group and the second portion of the memory cells based on a data structure,
wherein the data structure is generated based on the reliability characteristic data.

8. The method of claim 2, wherein the first memory cells are included in one or more first wordlines of the non-volatile memory device,
wherein the second memory cells are included in one or more second wordlines of the non-volatile memory device, and
wherein the one or more first wordlines and the one or more second wordlines are contiguous.

9. A solid-state drive (SSD), comprising:
a non-volatile memory device; and
a controller to:
determine, using a machine learning model, reliability characteristic data associated with wordlines of the non-volatile memory device;
determine, based on the reliability characteristic data, a first group of one or more first wordlines of the non-volatile memory device and a second group of one or more second wordlines of the non-volatile memory device; and
perform at least one of:
first background scanning of the first group of one or more first wordlines at a first frequency that is different than a second frequency of performing second background scanning of the second group of one or more second wordlines, or
logical to physical mapping of data to the first group of one or more first wordlines or to the second group of one or more second wordlines based on the data being a first type of data or a second type of data.

10. The SSD of claim 9, wherein a first marginality of the first group of one or more first wordlines exceeds a second marginality of the second group of one or more second wordlines, and
wherein, to perform the first background scanning, the controller is to:
perform the first background scanning at the first frequency that exceeds the second frequency based on the first marginality exceeding the second marginality.

11. The SSD of claim 9, wherein the first type of data is received from a host device,
wherein a first marginality of the first group of one or more first wordlines exceeds a second marginality of the second group of one or more second wordlines, and
wherein the controller is to cause the data to be stored in the second group of one or more second wordlines based on:
the first type of data being received from the host device.

12. The SSD of claim 9, wherein, to determine the first group of one or more first wordlines and the second group of one or more second wordlines, the controller is to:
determine the first group of one or more first wordlines and the second group of one or more second wordlines based on a data structure,
wherein the data structure is generated based on the reliability characteristic data.

13. The SSD of claim 12, wherein the data structure identifies different program/erase cycles associated with different wordlines with marginalities.

14. The SSD of claim 9, wherein the first group of one or more first wordlines and the second group of one or more second wordlines are contiguous.

15. A non-transitory computer-readable medium storing a set of instructions, the set of instructions comprising:
one or more instructions that, when executed by one or more processors of a one or more devices, cause the one or more devices to:
determine, using a machine learning model, reliability characteristic data associated with wordlines of a non-volatile memory device;
determine, based on the reliability characteristic data, a first group of one or more first wordlines of the non-volatile memory device and a second group of one or more second wordlines of the non-volatile memory device; and
perform, based on the reliability characteristic data, at least one of:
background scanning of the first group of one or more first wordlines and the second group of one or more second wordlines, or
logical to physical mapping of the first group of one or more first wordlines and the second group of one or more second wordlines.

16. The non-transitory computer-readable medium of claim 15, wherein the one or more instructions to perform the background scanning and the logical to physical mapping comprise:
one or more instructions to perform, based on the reliability characteristic data, background scanning of the first group of one or more first wordlines at a first frequency that is different than a second frequency of performing second background scanning of the second group of one or more second wordlines.

17. The non-transitory computer-readable medium of claim 16, wherein a first marginality of the first group of one or more first wordlines exceeds a second marginality of the second group of one or more second wordlines, and
wherein the first frequency exceeds the second frequency based on the first marginality exceeding the second marginality.

18. The non-transitory computer-readable medium of claim 15, wherein the one or more instructions to perform the background scanning and the logical to physical mapping comprise:
one or more instructions to perform logical to physical mapping of data to the first group of one or more first wordlines or to the second group of one or more second wordlines based on the data being a first type of data or a second type of data.

19. The non-transitory computer-readable medium of claim 18, wherein a first marginality of the first group of one or more first wordlines exceeds a second marginality of the second group of one or more second wordlines
wherein the first type of data is received from a host device, and
wherein the one or more instructions to perform the background scanning and the logical to physical mapping comprise:
one or more instructions to store the data in the second group of one or more second wordlines based on:
the data being the first type of data, and
the first marginality exceeding the second marginality.

20. The non-transitory computer-readable medium of claim 15, wherein the one or more instructions to determine the first group of one or more first wordlines and the second group of one or more second wordlines comprise:
one or more instructions to determine the first group of one or more first wordlines and the second group of one or more second wordlines based on a data structure,
wherein the data structure is generated based on the reliability characteristic data.
